(19) United States
(12) Patent Application Publication
(10) Pub. No.: US 2013/0321906 A1
(43) Pub. Date: Dec. 5, 2013

(54) ANNULUS TO CREATE DISTINCT ILLUMINATION AND IMAGING APERTURES FOR AN IMAGING SYSTEM

(71) Applicants: Peter KRIOFSKE, Seattle, WA (US); Kevin G. CASSADY, Monroe, WA (US)

(72) Inventors: Peter KRIOFSKE, Seattle, WA (US); Kevin G. CASSADY, Monroe, WA (US)

(21) Appl. No.: 13/902,105

(22) Filed: May 24, 2013

Related U.S. Application Data
(60) Provisional application No. 61/652,659, filed on May 29, 2012.

(51) Int. Cl. G02B 27/00

(52) U.S. Cl. CPC G02B 27/00
USPC 359/363; 359/434

(57) ABSTRACT

An imaging system for viewing both flat and angled surfaces of a test element, such as the end faces of both PC and APC optical fibers. A light source provides light to the angled surface, while lensing directs a portion of the original light to the angled surface at a second acute angle. A collector, e.g. photodetector, lenses or human eye, receives the portion of the light reflected from the angled surface and generates an image thereof. An annulus is provided in the optical path for managing the light. The annulus includes a transparent outer ring enabling the portion of the light to pass from the light source to the surface at the second acute angle; a central transparent section enabling light reflected from the angled surface to pass to the collector along the longitudinal optical axis; and a first light-blocking ring between the outer ring and the central section for blocking excess light from the light source and reflected from the end surface.

### CROSS-REFERENCE TO RELATED APPLICATIONS

The present invention claims priority from U.S. Patent Provisional Application No. 61/652,659 filed, May 29, 2012, which is incorporated herein by reference.

### TECHNICAL FIELD

The present invention relates to an imaging system, and in particular to an annulus to block light in the illumination path of an imaging system to enable viewing of both physical contact (PC) and angled physical contact (APC) fiber ends without the need of angled adaptors.

### BACKGROUND OF THE INVENTION

Loss is incurred, whenever a connector is installed on the end of an optical fiber. A portion of the light lost is reflected directly back down the optical fiber towards the source of the light. The back reflections, known as Optical Return Loss (ORL), will damage the light sources and disrupt the transmitted signal. To minimize loss, the end of the optical fiber is subjected to a variety of polish profiles, depending on the type of fiber and the application.

For single mode fibers, a physical contact (PC) polish results in the fiber ends being polished with a slight curvature, such that when the connectors are mated the fibers touch only at their cores. A typical hand polished PC connector will measure at −30 dB.

To reduce the back reflection of a connector, it can be polished to SPC (Super Physical Contact) polish or UPC (Ultra Physical Contact) polish. Industry standard is a minimum of −40 dB for SPC back reflection measurement and −50 dB for UPC back reflection measurement.

If even less back reflection is required, an Angled Physical Contact (APC) polish, in which an 8° angle is cut into the ferrule, may be required. APC connectors are identifiable by their green color. An APC polished connector has an Industry Standard Minimum f −60 dB ORL measurement, and APC fiber ends have low back reflection even when disconnected.

With reference to FIG. 1a, a PC fiber 1 with a ferrule 2 has a face 3, which is flat, i.e. perpendicular to the longitudinal optical axis of the fiber 1 and ferrule 2, so incident light parallel to the fiber 1 is reflected directly back. An APC fiber 6 with a ferrule 7, illustrated in FIG. 1b, has a face 8, which is slanted at 8° from the normal flat face, so incident light parallel to the fiber 6 is reflected at about 16°. Accordingly, an imaging system or microscope used to inspect a PC fiber cannot be used to adequately inspect an APC fiber unless an adaptor is used to position the APC fiber. The adaptor is needed to hold the face of the APC fiber perpendicular to the imaging system.

The industry standard for viewing PC and APC fibers with the same microscope, as disclosed in U.S. Pat. Nos. 7,312,859 issued Dec. 25, 2007 to Koudelka et al, and 8,104,976 issued Jan. 31, 2012 to Zhou et al, is to use special adapters to position the APC fiber, such that its face is normal to the imaging system. If an adapter is not used, then a lens with large numerical aperture (NA) is required to capture the light reflected off at 16°. But that large NA results in a depth of field too small to form an image.

An object of the present invention is to overcome the shortcomings of the prior art by providing an imaging system, which enables imaging of PC and APC fiber optic cable faces using the same optical system without incorporating adapters for the APC fiber.

### SUMMARY OF THE INVENTION

Accordingly, the present invention relates to an imaging system with a longitudinal optical axis for viewing an angled surface of a test element, which is at a first acute angle relative to a plane perpendicular to the longitudinal optical axis, comprising:

a light source providing light to the angled surface;

lensing for directing a portion of the light to the angled surface at a second acute angle, and for directing an image of the angled surface to a viewing plane; and

an annulus including:

a transparent outer ring enabling the portion of the light to pass from the light source to the surface at the second acute angle;

a central transparent section enabling light reflected from the angled surface to pass to the viewing plane along the longitudinal optical axis; and

a first light-blocking ring between the outer ring and the central section for blocking excess light from the light source and reflected from the angled surface.

Another aspect of the present invention relates to an imaging system with a first longitudinal optical axis for viewing an end surface of an optical fiber, which has a second longitudinal optical axis aligned with the first longitudinal optical axis, the end surface being flat or angled at a first acute angle relative to a plane perpendicular to the first and second longitudinal optical axes, the imaging system comprising:

a light source providing light to the end surface;

lensing for directing a first portion of the light to the angled end surface at a second acute angle relative to the second longitudinal optical axis when imaging an angled fiber, and for directing a second portion of the light at the flat end surface normal thereto when imaging a flat fiber;

a collector defining a viewing plane for receiving the first or second portion of the light reflected from the end surface; and

an annulus including:

a transparent outer ring enabling the first portion of the light to pass from the light source to the angled surface at the second acute angle;

a central transparent section enabling light reflected from the angled surface to pass to the collector along the second longitudinal optical axis, and enabling the second portion of the light to pass from the light source to the flat surface, and pass to the collector along the second longitudinal optical axis; and

a first light-blocking ring between the outer ring and the central section for blocking excess light from the light source and reflected from the end surface.

### BRIEF DESCRIPTION OF THE DRAWINGS

The invention will be described in greater detail with reference to the accompanying drawings which represent preferred embodiments thereof, wherein:

FIGS. 1a and 1b are side views of conventional PC and APC optical fiber ends;

FIG. 2 is an isometric view of an imaging system for viewing the ends of optical fibers, in accordance with the present invention;

FIG. 3 is a side view of the imaging system of FIG. 2;

FIG. 4 is a side view of the light path through the imaging system of FIG. 2;

FIG. 5 is an isometric view of a first embodiment of annulus in accordance with the present invention;

FIG. 6 is an isometric view of a second embodiment of an annulus in accordance with the present invention;

FIG. 7 is an isometric view of a beamsplitter in accordance with an alternate embodiment of the present invention; and

FIG. 8 is an isometric view of a lens in accordance with an alternate embodiment of the present invention

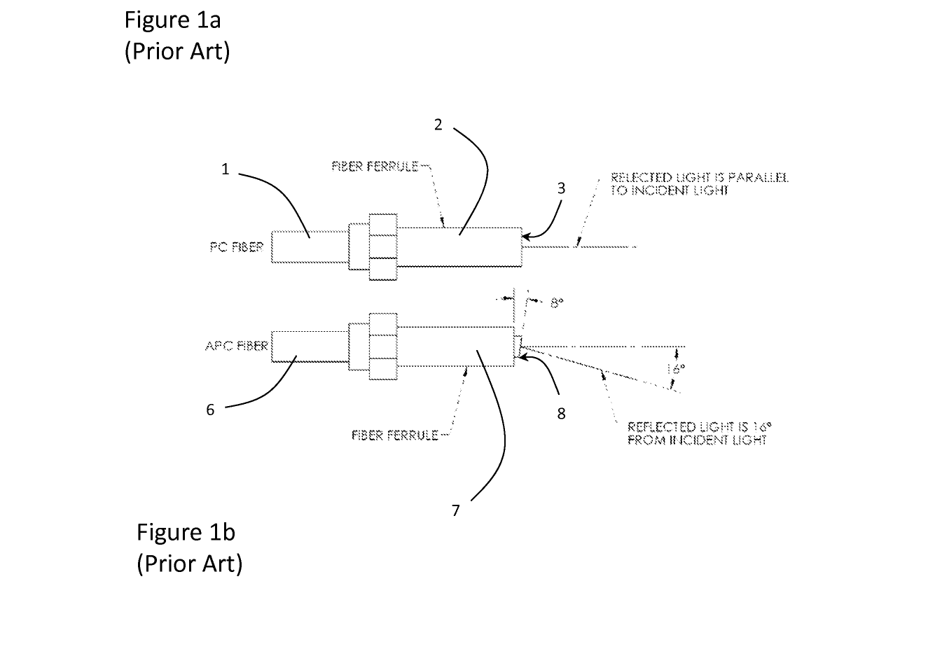

### DETAILED DESCRIPTION

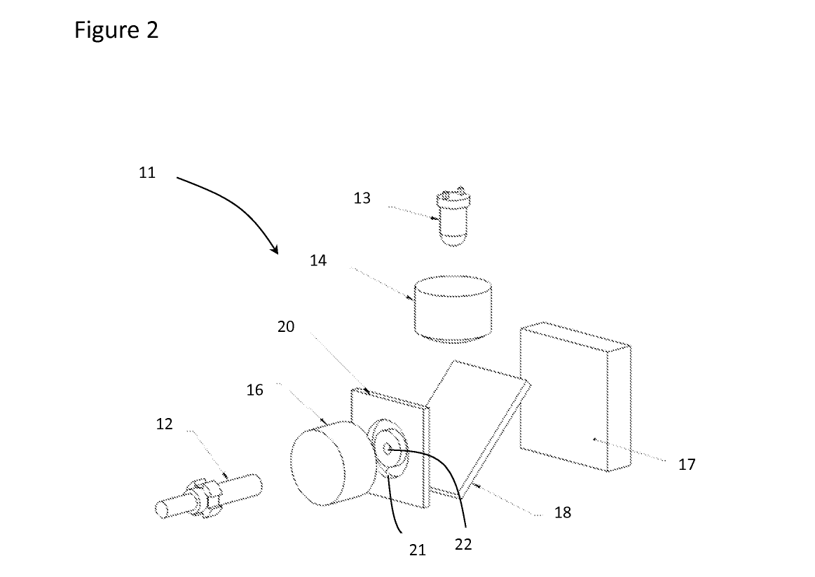

With reference to FIG. 2, a microscope 11 for examining the ends of optical elements, such the PC fiber 1 and the APC polished optical fiber 6, includes a light source 13 for generating light, a focusing lens 14 for focusing the light on the end face ⅜ of the optical fiber ⅙, and a imaging lens 16 for redirecting the light onto the end face ⅜ of the optical fiber ⅙ and for imaging the light reflected by the end face ⅜ of the optical fiber ⅙ onto a collector 17, e.g. photodetector for a video microscope or a lens for an optical microscope. The lenses 14 and 16 combine to provide lensing for the microscope system, which can include additional lenses at various locations depending on the requirements of the system. The collector 17 is essentially a viewing plane from which an image of the end face of the optical fiber 6 can be viewed or transmitted to a remote location. An eye piece and/or simply a human eye can be positioned at the collector viewing plane 17 to focus the image. Alternatively, additional optical elements can be used to transmit/focus the image onto a remote imaging plane. A beamsplitter 18, e.g. a 50/50 beamsplitter, redirects a portion of the light from the lightsource 13 perpendicular to its original originating axis towards the end face ⅜ of the optical fiber ⅙, and passes a portion of the light reflected from the fiber ⅙ to the collector 17

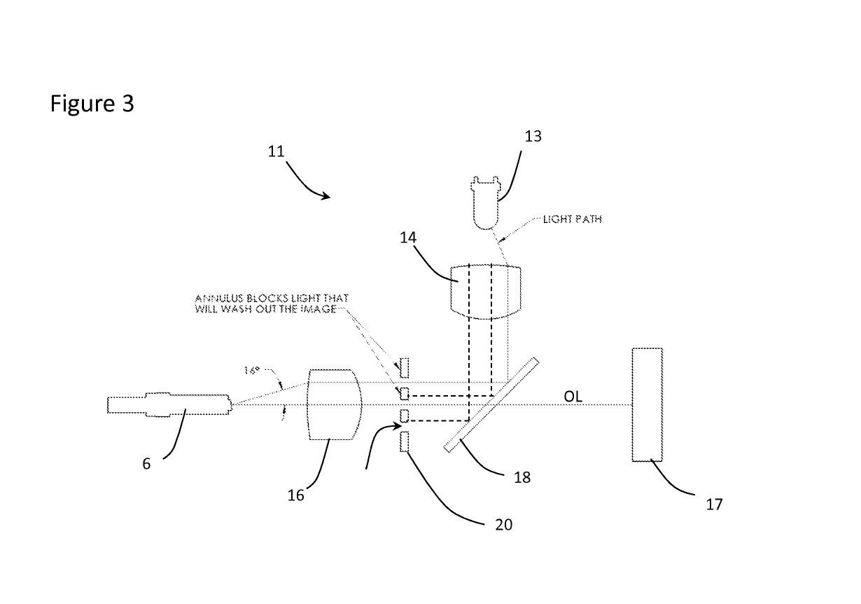

An annulus 20 is disposed in the illumination light path of the microscope 11, either between the lens 16 and the beamsplitter 18 or between the lens 14 and the beamsplitter 18. The annulus has an NA greater than 0.28, to eliminate the need for special adapters. The annulus 20 creates two transparent apertures: a center/imaging aperture 22, e.g. NA of about 0.15, and a ring light aperture 21, having an NA approximately twice that of the center aperture, e.g. NA of about 0.27 or more, both surrounded by opaque or reflective portions. The center/imaging aperture 22 reduces the overall NA of the lens 16, which creates a usable image for small particle detection. The 0.27 NA ring light aperture 21 sends light to the APC fiber 6 at an acute angle, e.g. twice the angle of the face 8 of the fiber 6 or 16° relative to normal (see FIG. 3). The 16° incident light is 8° relative to the APC fiber face 8 at any given rotational orientation of the fiber 6, and it's this light that is reflected back to the collector 17 by the 8° APC fiber surface 8. The rest of the light is scattered by the end face 8 of the optical fiber 6 or the opaque/reflective portions of the annulus 20. That scattered light, known as noise, would wash out the image if not for the center/imaging aperture 22. Also, the ring of light blocked by both the front and rear opaque surfaces of the annulus 20 would otherwise produce too much noise to resolve the image.

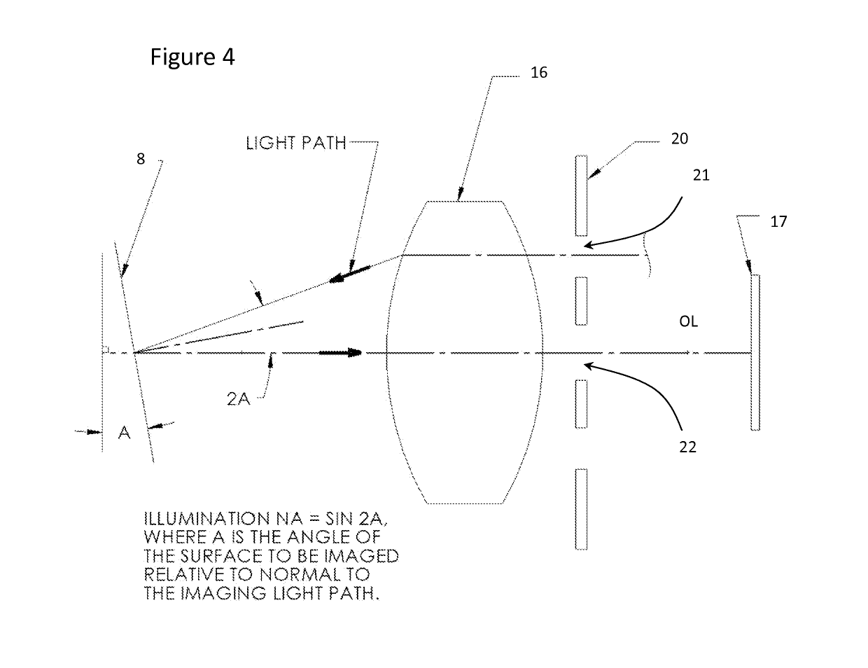

With reference to FIGS. 3 and 4, light for imaging the end of the APC fiber 6 travels from the light source 13, along an originating axis through the focusing lens 14, a portion of which reflects off of the 50/50 beamsplitter 18, along an axis perpendicular to the originating axis and parallel to the longitudinal optical axis OL of the microscope 11 through the ring light aperture 21 of the annulus 20, through an upper section of the imaging lens 16, which redirects the portion of light at an acute angle from the longitudinal optical axis OL, e.g. twice the angle A of the end face 8 or 16°, to the end face 8 of the optical fiber 6. The angle of incidence of the portion of light is actually 8° from the normal to the end face 8, i.e. the same angle as the end face 8 is from a flat face, which is perpendicular to the longitudinal optical axis OL, whereby the end face 8 reflects the portion of light along the longitudinal optical axis OL. The face 8 of the fiber 6 then reflects the portion of light back along the longitudinal optical axis OL through the center of the imaging lens 16, the center hole 22 of the annulus 20, and the beamsplitter 18 to the collector 17, which generates an image of the end of the APC fiber 6.

With reference to FIG. 4, from the lens 16, the light travels at an acute angle, e.g. 16°, from a centerline extending through the longitudinal axis of the fiber 6 and lens 16, i.e. twice the angle that the fiber face 8 makes with a line perpendicular to the longitudinal axis, e.g. 8°. Accordingly, the angle of incidence of the light approaching the fiber face 8 is equal to the angle of the fiber face 8, whereby the fiber face 8 reflects the light at an equal angle of reflection, e.g. 8°, from the normal of the fiber face 8, so that the light is reflected along the longitudinal optical axis OL.

Light for imaging a PC fiber, with a flat endface, travels from the light source 13, straight through the focusing lens 14, off of the 50/50 beamsplitter 18, through the center hole of the annulus 20, through the imaging lens 16 to the face of optical fiber 1, and then straight back through the imaging lens 16, the center hole of the annulus 20, and the beamsplitter 18 to the collector 17.

The NA of the ring-light aperture is large enough to not adversely affect illumination or imaging of the PC fiber through the center aperture.

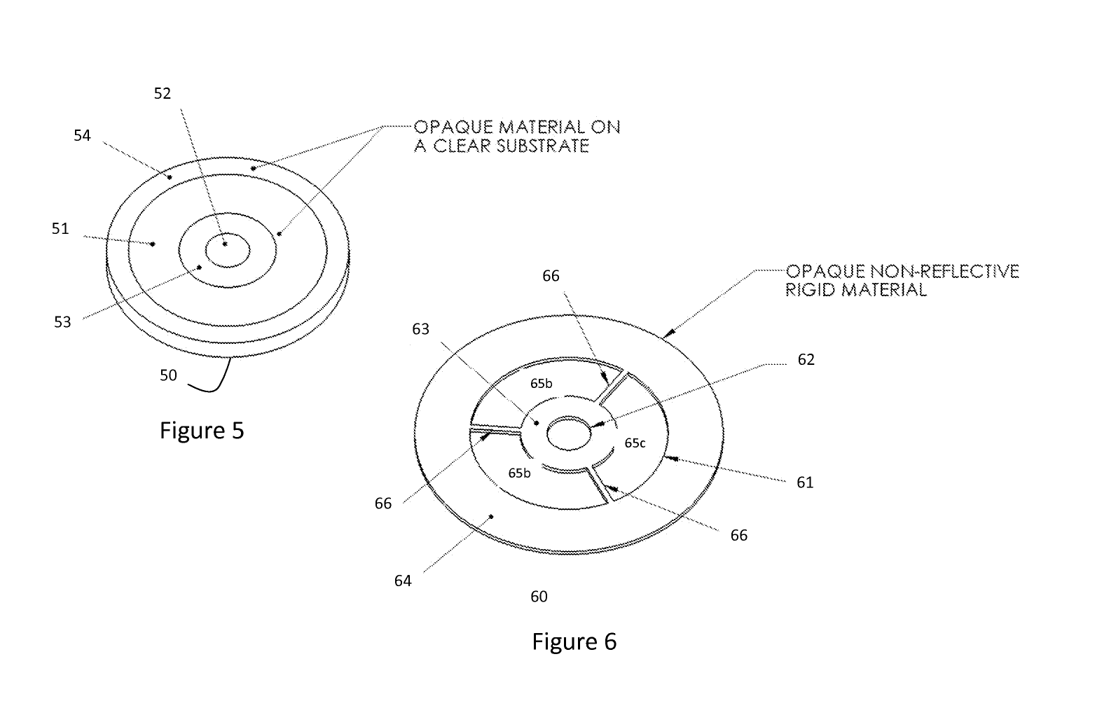

With reference to FIGS. 5 and 6, the annulus 20 can take various forms. FIG. 5 illustrates the annulus 50 as including a ring of transparent material forming a ring light aperture 51, and a circular (or cylindrical) section of transparent material forming a center/imaging aperture 52. Opaque, preferably non-reflecting, rings 53 and 54 surround the center/imaging aperture 52 and the ring 51, respectively, for blocking the transmission of light therethrough. Each section 51, 52, 53 and 54 can be separate elements fitted together or the opaque rings 53 and 54 can simply be coated onto a clear substrate, which forms the transparent center/imaging aperture 52 and ring light aperture 51.

A filter medium can be used on a clear substrate of ring light aperture 51 and center/imaging aperture 52 to image a surface using a particular wavelength of light from the lightsource 13, while reflecting the rest of the wavelengths.

Alternatively, an annulus 60 can be constructed out of an opaque, non-reflective, material with arcuate or block arc sections 65a, 65b, 65c removed therefrom, forming openings into a ring light aperture 61, and a circular section removed therefrom, forming an opening into the center hole forming a center/imaging aperture 62. Spokes 66 extend from an outer non-reflecting ring 64 to an inner non-reflecting ring 63.

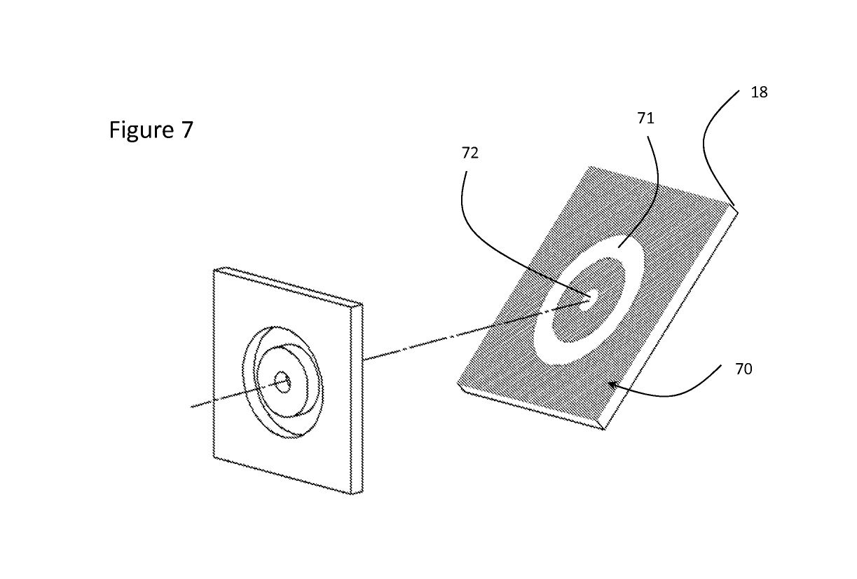

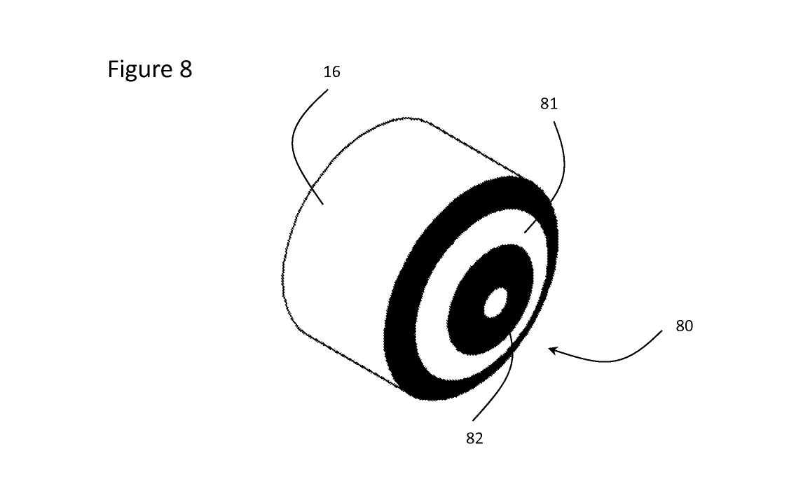

The annulus 20 could also be a projection 70, forming the light blocking rings, coated onto or formed of a separate opaque or non-reflective material mounted onto the beam splitter 18, as illustrated in FIG. 7 defining a transparent ring-light center aperture 71 and a transparent center/imaging aperture 72. Alternatively, as illustrated in FIG. 8, the annulus 20 can be an opaque or non-reflective coating 80, e.g. “printed”, on the lens 16 to define a transparent ring-light aperture 81 and transparent center/imaging aperture 82 surrounded by the light blocking rings.

The size of the ring-light aperture 21/51/61/71/81 and the center/imaging aperture 22/52/62/72/82 are dependent on the overall optical system (lenses, camera, LED, etc.). The illustrated annulus 20/50/60/70/80 have holes for the center/imaging apertures 22/52/62/72/82 with a radius of greater than 1″ and between 1″ and 3″, e.g. 2″, and a ring light aperture 21/51/61/71/81 with an ID of more than 2× the radius of the center hole for the center imaging aperture 22/52/62/72/82, e.g. 4.4″, and an OD of more than 2× the ID, e.g. 9″.

In general, this same lighting technique could be used to view any angled surface on a fiber or other DUT between 0° and 45° from flat (perpendicular to longitudinal axis), non-inclusive. At 0° the annulus is pointless, and at 45° the system “blows up”. This is the point where system design comes into play. Specifically, as seen in FIG. 4, illumination NA created by the annulus 20 is equal to SIN 2A where A is the angle of the surface 8 to be viewed relative to normal to the imaging light path, i.e. longitudinal optical axis OL. The ring light portion 21 of the annulus 20 is dependent on the illumination NA. The hole in the center, i.e. the center/imaging aperture 22, is also dependent on the optical system design.

The light blocking feature of the annulus 20 is needed to prevent too much noise, but how much light to block must be determined by the optical system design. In general, referring to FIG. 4, the inner and outer diameters of the ring light portion 21 and the center/imaging aperture 22 of the annulus 20 are too dependent on overall optical design (light source, wavelengths, collector, lenses, etc.) to be specified herein.

We claim:

1. An imaging system with a longitudinal optical axis for viewing an angled surface of a test element, which is at a first acute angle relative to a plane perpendicular to the longitudinal optical axis, comprising:
a light source providing light to the angled surface;
lensing for directing a portion of the light to the angled surface at a second acute angle, and for directing an image of the angled surface to a viewing plane; and
an annulus including:
a transparent outer ring enabling the portion of the light to pass from the light source to the surface at the second acute angle;
a central transparent section enabling light reflected from the angled surface to pass to the viewing plane along the longitudinal optical axis; and
a first light-blocking ring between the outer ring and the central section for blocking excess light from the light source and reflected from the angled surface.

2. The imaging system according to claim 1, further comprising a collector disposed at the viewing plane for receiving the portion of the light reflected from the angled surface and generating an image thereof.

3. The imaging system according to claim 2, wherein the collector comprises a photodetector for generating an image of the angled surface of the test element.

4. The imaging system according to claim 2, wherein the collector comprises an optical element for transmitting the image to a remote image plane.

5. The imaging system according to claim 1, further comprising a beamsplitter for directing light from an originating path of the light source to a path perpendicular to the originating path and parallel to the longitudinal axis of the imaging system, and for passing light from the angled surface to the collector.

6. The imaging system according to claim 5, wherein the beamsplitter comprises the annulus.

7. The imaging system according to claim 1, wherein the lensing comprises the annulus.

8. The imaging system according to claim 1, wherein the annulus comprises a transparent substrate; and an opaque coating forming the first light blocking ring.

9. The imaging system according to claim 8, wherein the transparent substrate includes a wavelength filter coating in the outer ring and/or the central section for passing only a particular wavelength of light to the collector.

10. The imaging system according to claim 1, wherein the annulus comprises an opaque material with sections removed defining the outer ring and central section.

11. The imaging system according to claim 1, wherein the second acute angle is twice the first acute angle.

12. The imaging system according to claim 1, wherein the central section has an NA equal to sin(2×first angle).

13. The imaging system according to claim 1, wherein the outer ring has an NA about twice that of the central section.

14. The imaging system according to claim 1, wherein the outer ring has an NA of about 0.15, and the central section has an NA of about 0.27.

15. An imaging system with a first longitudinal optical axis for viewing an end surface of an optical fiber, which has a second longitudinal optical axis aligned with the first longitudinal optical axis, the end surface being flat or angled at a first acute angle relative to a plane perpendicular to the first and second longitudinal optical axes, the imaging system comprising:
a light source providing light to the end surface;
lensing for directing a first portion of the light to the angled end surface at a second acute angle relative to the second longitudinal optical axis when imaging an angled fiber, and for directing a second portion of the light at the flat end surface normal thereto when imaging a flat fiber;
a collector defining a viewing plane for receiving the first or the second portion of the light reflected from the angled or the flat end surface, respectively; and
an annulus including:
a transparent outer ring enabling the first portion of the light to pass from the light source to the angled surface at the second acute angle;
a central transparent section enabling light reflected from the angled surface to pass to the collector along the second longitudinal optical axis, and enabling the second portion of the light to pass from the light source to the flat surface and pass back to the collector along the second longitudinal optical axis; and
a first light-blocking ring between the outer ring and the central section for blocking excess light from the light source and reflected from the end surface.

16. The imaging system according to claim 15, wherein the collector comprises a photodetector for generating an image of the end surface of the optical fiber.

17. The imaging system according to claim 15, wherein the collector comprises an optical element for viewing an image of the end surface or transmitting the image to a remote image plane.

18. The imaging system according to claim 15, further comprising a beamsplitter for directing light from an originating path of the light source to a path perpendicular to the originating path and parallel to the longitudinal axis of the imaging system, and for passing light from the end surface to the collector.

19. The imaging system according to claim 18, wherein the beamsplitter comprises the annulus.

20. The imaging system according to claim 15, wherein the lensing comprises the annulus.
